(19) United States
(12) Patent Application Publication
(10) Pub. No.: US 2020/0265962 A1
(43) Pub. Date: Aug. 20, 2020

(54) OBJECTS OF THINGS SYSTEM

(71) Applicant: BADR M. AL REFAE, Chennai (IN)

(72) Inventor: BADR M. AL REFAE, Chennai (IN)

(21) Appl. No.: 16/099,066

(22) PCT Filed: May 10, 2017
(86) PCT No.: PCT/IB2017/000611

§ 371 Date: Nov. 5, 2018

(30) Foreign Application Priority Data
May 13, 2016 (IN) 201641016829

(51) Int. Cl. G16Y 40/35; G16Y 40/50; G16Y 20/40; G06Q 20/30; G07C 9/32

(52) U.S. Cl. CPC G16Y 40/35; G16Y 40/50; G07C 9/32; G06Q 20/308; G16Y 20/40

(57) ABSTRACT

The present invention relates to system [202] and method for communicating using Objects [210] that are virtual software containers. Further, the present invention relates to a unique system [202] for management of objects of things, which can link to files, URL links, apps and chats and said objects can be customized, configured or organized by the user [201] or entity [250] based on their needs. Accordingly, the object [210] can be accessed, shared and store the type of contents using portable devices [203] via internet and also share with other users such as social media and email services. Advantageously, the present invention can eliminate the need to use of a physical card to gain access to doors, cars, ATM(s) and other financial and non-financial services thereby reducing the security risks associated with the use of physical cards.

### FIELD OF THE INVENTION

The present invention relates to system and method for communicating using Objects that are virtual software containers. More particularly, the present invention relates to a unique system for management of Objects of Things, which can be customized by a user or an organization according to their needs using portable devices. Further, the present invention relates to a unique system for management of Objects of Things, which can link to files, URL links, apps and chats and said Objects can be organized using portable devices and shared with other users using the present invention, social media and email services.

### BACKGROUND OF THE INVENTION

Generally, enterprises and organizations expose their business information and functionality on the web through software applications, usually referred to as web applications. Web applications provide great opportunities for an organization. The web applications use the Internet technologies and infrastructures. Consumers access these services through many different apps that lack a common method of delivering the services to consumers. On the other hand, consumers communicate and exchange a wide variety of information amongst themselves that also lack a common method of exchanging and organizing this information. Currently, a user is overwhelmed and many a times confused with the explosion in the mobile device applications and the services it provides. FIG. 1 is a flow diagram illustrating how users access mobile apps on their smart devices and computer devices according to the prior art.

EP2840813 is a service method in an internet of things environment may include displaying a message to another instance using a feeder interface among interfaces included in an instance of a virtualization object about a thing; receiving a message displayed from a feeder interface of the other instance or the thing using a subscriber interface among the interfaces; transferring a message to the other instance or the thing using a controller interface among the interfaces; receiving a message transferred from a controller interface of the other instance using a receiver interface among the interfaces; and interacting with a 3rd party service using an authentication interface among the interfaces.

WO2015111787 discloses an intelligent object service based on the formation of an autonomous Social Collaboration Group and more particularly to a method for providing an intelligent object service by forming a social collaboration group autonomously between objects, and to provide intelligent object services through collaborations between objects based on the objects. This provides a Collaboration Service based on an Overlay Network formed between objects on an M2M Network. It acquires metadata related to a profile of the overlay network; and forms one or more social collaboration groups including a part or all of the objects constituting the overlay network, based on the metadata and selects a coordinator terminal acting as an intermediary or coordinator within the social collaboration group based on the metadata. This invention imparts an effort for grouping social association through objects. However, it does not show any efficient way to provide customized services especially financial and non-financial services.

Accordingly, there exists a need for a unique system for management of Objects of Things, which can be customized by a user or an organization according to their needs using portable devices. Further, there exists a need for a unique system for management of Objects of Things, which can link to files, URL links, apps and chats and these objects can be organized using portable devices and shared with other users using the present invention, social media and email services.

### Objects of the Invention

One or more problems of the prior art may be overcome by various embodiments of the system and methods of the present invention.

It is the primary object of the present invention to provide a unique system for management of Objects of Things, which can be customized by a user or an organization according to their needs using portable, wearable or desktop devices.

It is another object of the present invention to provide a unique system for management of Objects of Things, which can link to files, URL links, apps and chats and said Objects can be organized and link to dynamic dashboards using portable, wearable or desktop devices and shared with other users using the present invention, social media and email services.

It is another object of the present invention to enable Apps developers to develop Apps User Interfaces or screens so they can be accessed from within the individual Objects of the Object of Things System thus delivering user interfaces that can be accessed through dynamic dashboards and objects by users across multiple apps, hardware and software platforms.

It is another object of the present invention is to allow users to communicate with their personal and/or business contacts using dynamic dashboards that contain objects; an act that is referred to here as dynamic dash boarding.

It is another object of the present invention to provide a system for management of objects of things, which can be published by organizations or individuals and accessed by consumers over the internet and other networks across multiple hardware and software platforms.

### SUMMARY OF INVENTION

Thus according to the basic aspect of the present invention provided a system for management of objects of things comprising of:
one or more objects or intelligent objects;
one or more nested objects or nested intelligent objects;
one or more internet objects or intelligent internet objects;
one or more nested internet objects or nested intelligent internet objects;
entities system;
server; and
one or more portable, wearable or desktop devices,
wherein the user connects to his objects or issuer of the objects that are connected and displayed on the dynamic dashboards through the nested object on his portable device, wearable or desktop device via wired or wireless communication networks, and
wherein each object can be configured by the user to define how the object is accessed and shared and the type of contents it can store.

It is another aspect of the present invention, wherein each object and its contents has a unique identifier.

It is another aspect of the present invention, wherein the objects are linked to dynamic dash boards via one or more portable devices.

It is another aspect of the present invention, wherein the user can select the objects and publish the selected objects over an internet or via one or more private networks and display the objects in dynamic dash board.

It is another aspect of the present invention, wherein the user can select an item or items within an object and post the selected items directly to another object or objects over the internet or via one or more private networks and update the status of the affected objects on the linked dynamic dashboards.

It is another aspect of the present invention, wherein once published, the selected objects will become internet objects and are searchable and accessible over the internet or via private networks.

It is another aspect of the present invention, wherein the entities system communicates and provides services directly to their users through the internet objects via internet or via one or more private networks.

It is another aspect of the present invention, wherein the user accesses their system for management of objects of things both from their local devices and over the internet using dynamic dashboards or via private networks using the portable device.

It is another aspect of the present invention, wherein the system for management of objects of things displays the internet objects that are linked to the user or devices based on the locations, and timings, or the like, which are conditionally displayed on the dynamic dashboards.

It is another aspect of the present invention, wherein the system for management of objects of things provides the user access to the local objects stored on the portable devices as well as all linked objects residing on the local devices or other devices and/or clouds.

It is another aspect of the present invention, wherein the portable device includes but not limited to mobile device or a tablet, or an iPad, or desktop devices, or wearables or other similar devices or a computer terminal or any other computer devices and/or the like.

It is another aspect of the present invention, wherein the system provides simple and direct media channels that are user centric and preserve direct relationships between the users and service providers.

It is another aspect of the present invention, wherein the direct media channels between the users created through the internet objects can provide different types of services or links to services.

It is another aspect of the present invention, wherein the internet objects eliminate the need to use the physical card to gain access to doors, cars, ATM(s) and other financial and non-financial services thereby reducing the security risks associated with the use of physical cards.

It is another aspect of the present invention, wherein the objects can be displayed to the users based on certain conditions stipulated by the objects creators and providers and link to dynamic dashboards.

It is another aspect of the present invention, wherein the system provides object trajectories to display the paths, the objects follow to retrieve or deliver data, user interfaces and/or programs sequences or states.

It is another aspect of the present invention, wherein a method for managing objects of things using a system, can be customized by a user or an organization according to their needs using portable devices comprising steps of:
registering and logging of user into the system for management of objects of things through a registered portable device;
checking if any condition has been programmed for internet objects by creators of the object;
displaying the condition based internet objects if any of the programmed conditions are met; and
selecting the objects and publishing the selected objects in the dashboard over an internet or via one or more private networks.
selecting items and posting the selected items directly to objects over an internet or via one or more private networks.
communicating and sharing objects with other users registered with the objects of things management system or through other social media and communication services.

It is another aspect of the present invention, wherein if the user did not select the system settings then the system will open the object selected by the user which will allow him to access specific objects of things.

It is another aspect of the present invention, wherein when the selected object is opened, the system will display options that include but not limited to search or manage new, object settings, or the like, allowing the user to search within a specific object, objects and/or the objects of things system.

It is another aspect of the present invention, wherein a user is able to perform unattended services and Checkout at Brick and Mortar Store.

It is another aspect of the present invention, wherein a user is able to perform unattended services include but not limited to cash withdrawal at ATMs or fuel dispensing at petrol stations or the like.

It is another aspect of the present invention, wherein a user is able to perform attended services at service locations such as bank locations, utilities, corporate offices, government and immigration service points, airplanes, ships, trains, or the like.

It is another aspect of the present invention, wherein a user is able to attend to personal services at personal service locations such as a home and accesses a garage door, a car, devices, lights or the like.

### BRIEF DESCRIPTION OF THE DRAWINGS

So that the manner in which the features, advantages and objects of the invention, as well as others which will become apparent, may be understood in more detail, more particular description of the invention briefly summarized above may be had by reference to the embodiment thereof which is illustrated in the appended drawings, which form a part of this specification. It is to be noted, however, that the drawings illustrate only a preferred embodiment of the invention and is therefore not to be considered limiting of the invention's scope as it may admit to other equally effective embodiments.

FIG. 1: is a block diagram illustrating how users access mobile apps on their smart devices and computer devices according to the prior art.

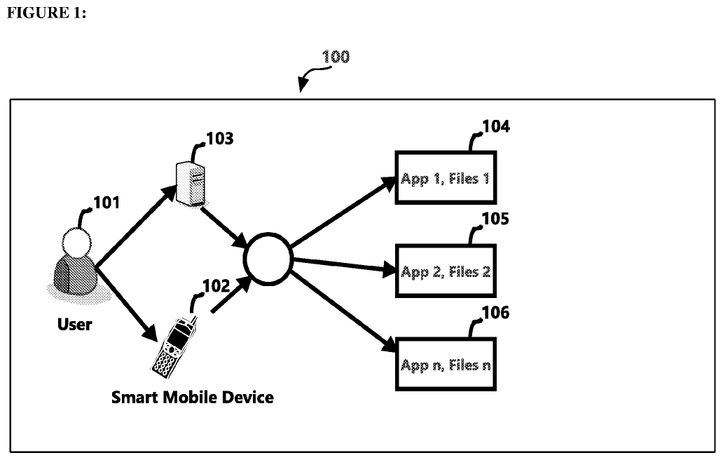

FIG. 2: illustrates a block diagram of the system for management of objects of things according to the present invention.

FIG. 3: illustrates a process flow chart of the system for management of objects of things according to the present invention.

FIG. 4: illustrates a process flow chart of the intelligent objects in the system for management of objects of things according to the present invention.

FIG. 5: illustrates a process flow chart of accessing intelligent object with new program generation in the system for management of objects of things according to the present invention.

### DETAILED DESCRIPTION OF THE INVENTION WITH REFERENCE TO THE ACCOMPANYING FIGURES

The present invention as herein described relates to a system for managing object of things which can be customized by a user or an organization according to their needs using portable devices.

### Keywords

The following are keywords and their descriptions referred to in this document:

Things: Any virtual or software thing or links such as but not limited to links to live streams and feeds, data, barcodes, Unique Identifiers, video, audio, text, Interactive Voice Response (IVRs), embedded web services, services, devices and/or software programs.

Object: a Virtual Container that can contain Things and/or other Objects connected physically, virtually or over networks.

Dynamic Dashboards: allows users to share with their personal and/or business contacts a whole dashboard of objects or things. A user can post items or publish Objects to his Contacts' Dynamic Dashboards, Search, Add, delete and even recall items or Objects from Dynamic Dashboards after he has published objects or posted items.

Dynamic Dashboarding: the act of communicating using dynamic dashboards that are linked to objects.

Object Trajectory: the paths the objects follow to retrieve or deliver data, user interfaces and/or programs

User Interface: any prompts the user receives from software programs

Nested Objects: Objects that are contained within other Objects (Internet Objects, Intelligent Objects, etc.).

Internet Object: an object that has been published over the Internet and/or networks.

Internet of Objects: collections of Internet Objects, Intelligent Internet Objects, and/or networks of Internet of Objects.

Intelligent Objects: Objects and/or Internet Objects that are Programmable and/or Self-Programmable.

The Objects of Things: collections of Objects, Internet Objects, Internet of Objects, Intelligent Objects and/or networks of all types of Objects.

Condition-Based Objects: Objects that embodies conditions set by the Object of Things creators and/or publishers.

Publish: the act of posting an Object on the Internet or Networks.

Post: the act of posting an item into an Object.

Broadcast: the act of broadcasting things to a set, groups and/or networks of Object of Things over the Internet or the Networks.

Global Objects Servers (GOS): servers that host private and publicly listed Objects of Things and/or their directories, contents and/or links.

GOS Networks: networks that result from connecting a single and/or multiple GOS and/or networks to a single and/or multiple GOS network and/or networks.

Consumer/User: refers to any user who has access to Objects of Things which can be an individual consumer or a user within an organization.

Entity: an individual professional or organization that publishes Objects over the Internet or networks.

Unique Identifier: any unique reference that can identify an object, an account, an account holder, a device, a physical or a virtual location or thing.

Service location: any physical or virtual location that provides services using the Objects of Things.

Service Hot Spot: any physical service location that is equipped with Wi-Fi connectivity.

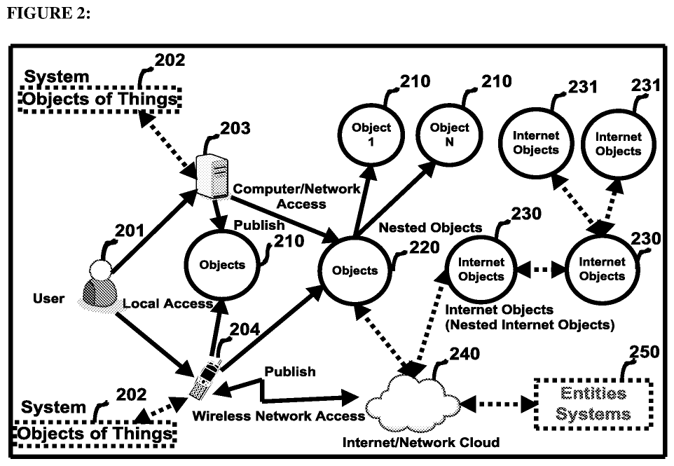

Referring to FIG. 2, the system [202] for management of Objects of Things through a server comprises of one or more Objects or Intelligent Objects [210]; one or more nested Objects or nested Intelligent Objects [220]; one or more Internet Objects or Intelligent Internet Objects [231]; one or more nested Internet Objects or nested Intelligent Internet Objects [230] [all Objects types can be displayed on dynamic dashboards]; entities system [250]; and one or more portable, wearable or desktop devices [203]. The user [201] connects to his Objects [210] or issuer/provider/creator of the Objects [210] through the nested Object [220] via wired or wireless communication networks [240] on his portable, wearable or desktop device [204]. Each Object [210] can be configured by the user [201] to define how the Object [210] is accessed and shared and type of contents it can store. The Objects contain Things such as data and Apps that are stored physically or by reference based on user's settings for different data and apps. If set by reference, then the actual file is not stored and only the link reference will be stored and while accessing the content of a file or App, the content is actually read from the original source.

The user [201] can select the Objects [210] or items within the Objects and publish or post the selected items or Objects [210] over an Internet or via one or more private networks [240]. Once published, the selected Objects [210] will become Internet Objects [231] or nested Internet Objects or nested Intelligent Internet Objects [230] and are searchable and accessible over the Internet or via private networks [240]. The entities system [250] communicates and provides services directly to their consumers through the Internet Objects [231] or nested Internet Objects or nested Intelligent Internet Objects [230] via Internet or via one or more private networks [240]. The user [201] accesses their system [202] for management of objects of things over the Internet or via private networks [240] using their portable, wearable or desktop device [204]. The portable device [204], [203] includes but not limited to mobile device or a tablet, an iPad, and other similar devices or a computer terminal, desktop, wearable or any other computer devices. The system [202] for management of Objects of Things displays the Internet Objects [231] or nested Internet Objects or nested Intelligent Internet Objects [230] that are linked to the user's devices [203],[204] locations, timings settings, etc. which can be displayed using dynamic dashboards.

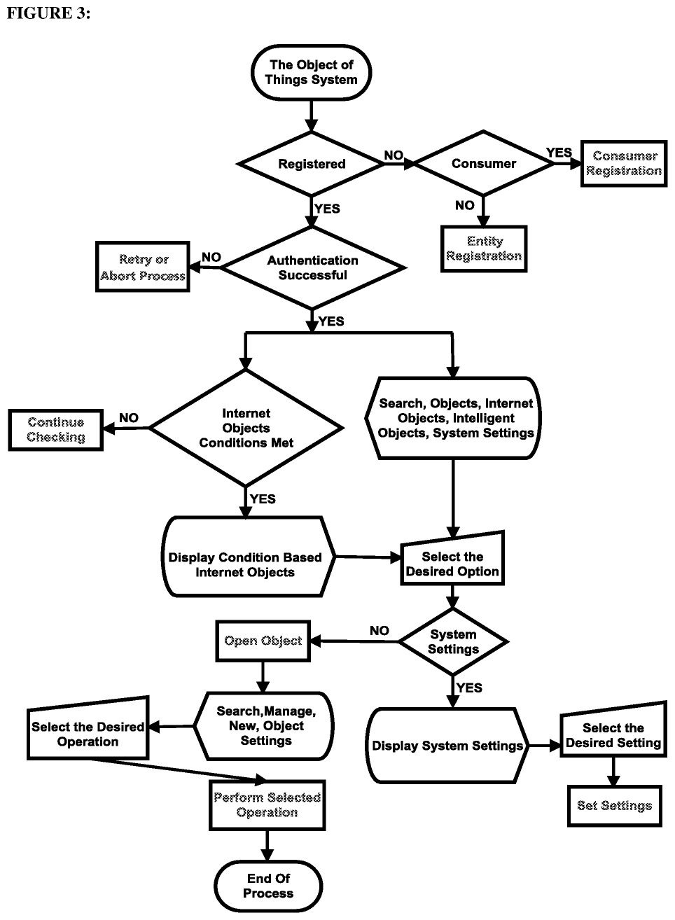

Referring to FIG. 3, the method for managing Objects of Things through a system is as follows: A user accesses the system for management of Objects of Things through a registered portable device. The user is prompted to register if he has not already registered with the system. If the user is a consumer then he will be directed to complete the consumer registration process. On the other hand, if the user is an entity acting on behalf of an organization or as an individual such as professionals he will be directed to complete the entity registration process. The user will need to be authenticated by the system through a registered portable device after the registration process.

If the authentication process is successful, the system will check if there any conditions that have been programmed for Internet Objects stipulated by the Objects creators and providers and if any of the conditions are met then the condition based Internet Objects will be displayed along with the other options. The other options are displayed which includes but not limited to searching all the system Objects of Things or the user can select specific Objects from a list of Objects, Internet Objects and Intelligent Objects. The system settings will allow the user to select settings related to the Object of Things system. If the user selected system settings, then system will direct the user to where all system settings options will be displayed. The user will make his settings selection and the system will perform the selected setting.

If the user did not select system settings then, the system will open the Object selected by the user which will allow him to access specific Objects of Things. When the selected Object is opened the system will display options that include but not limited to search, manage, new, object settings, etc. allowing the user to search within a specific Object, manage an Object operation such as add, attach, edit, delete, recall, publish, broadcast, share, etc. The user can also create new Objects and manage the settings of an Object. The Object settings relate to a specific Object such as restricting sharing of an Object by changing the privacy settings for an Object in addition to other Object settings. The user can also select settings that can be applied to specific items within an Object, for example, restricting the sharing of a specific item within an Object. The user will make his selection for a specific operation and system will perform the selected operation and the process will end.

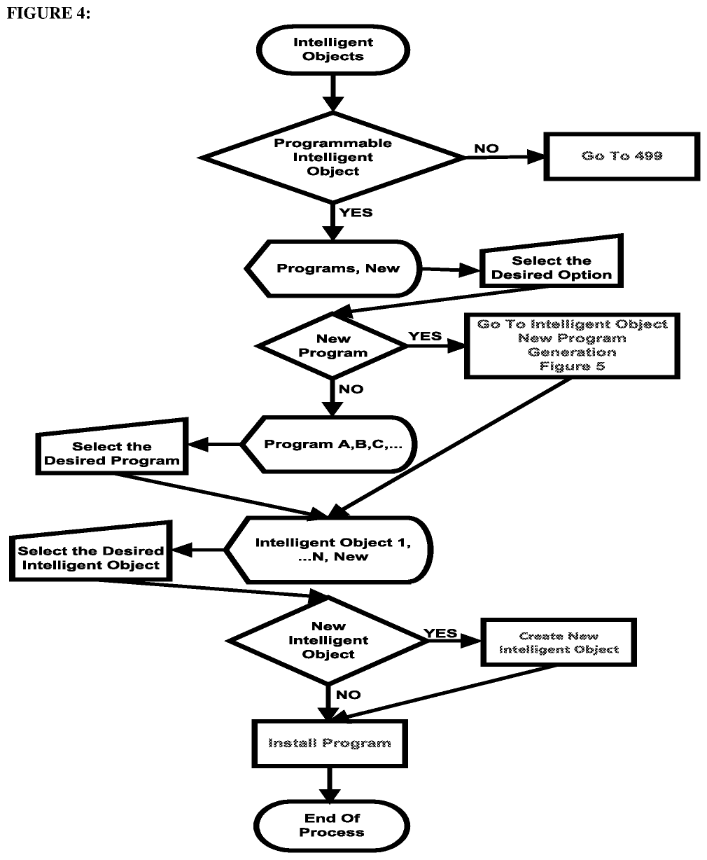

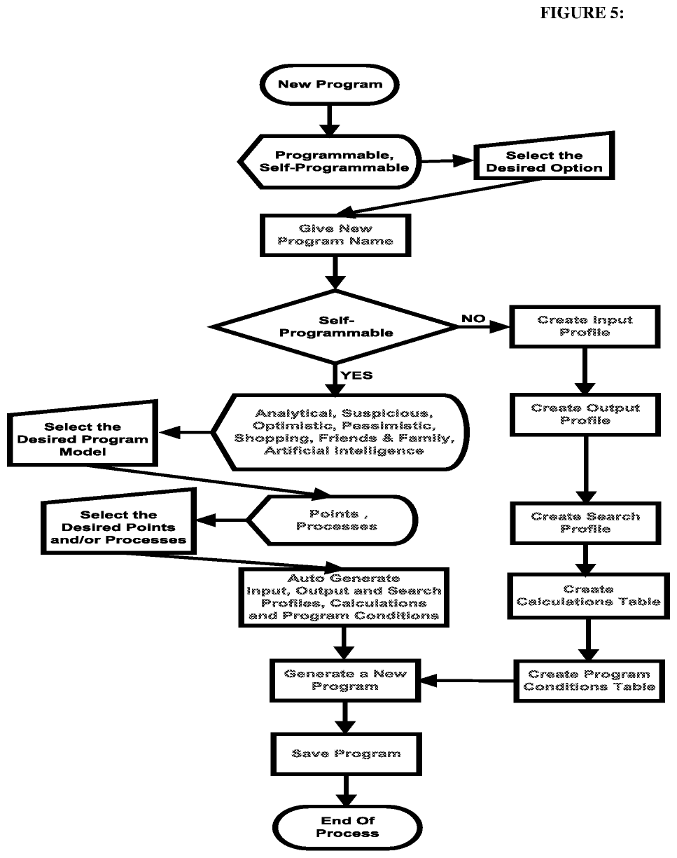

Referring FIGS. 3 and 4, the user accesses the Intelligent Objects via a portable device, said Intelligent Objects have the capabilities to share, import and export data, services, apps and information with other Intelligent Objects and external applications. The Intelligent Objects check to ensure that the user desires to access the Intelligent Objects. If the user desires to access the Intelligent Objects, the Intelligent Objects displays two options for the user to choose from namely, existing or new programs and the user confirms his selection. The Intelligent Objects checks if the user has selected new program and if it is true, then the user is directed to Intelligent Objects new program generation module as shown in FIG. 5.

Otherwise, the user is displayed with a list of all existing programs and the user selects the desired program. Next the Intelligent Objects displays two options for the user to choose from namely, all existing Intelligent Objects or new Intelligent Object and the user confirms his selection. The Intelligent Objects checks if the user has selected new Intelligent Object and if it is true, then the user creates a new Intelligent Object and proceeds to install the existing or the newly generated program as shown in FIG. 5 for this newly created Intelligent Object. Otherwise, the user proceeds to install the existing or the newly generated program in the existing intelligent object selected by the user and the process is ended.

Referring to FIGS. 3 and 5, the user accesses a new Program Generation Module Intelligent Objects of the system via a portable device. The Intelligent Objects new program generation module displays two options for the user to choose from namely, programmable or self-programmable meaning manually programming an Intelligent Object program or the Intelligent Object program is capable of programming itself. The user gives a name to either of the newly to be generated programmable or self-programmable program options. The Intelligent Object new Program Generation Module checks the user's selection that was processed. If the user does not select the self-programmable, then the user is directed to create the input profiles for the programmable Intelligent Object. The input profiles provide all program data inputs field names and their properties, i.e., numeric, alphanumeric, lengths, etc.

The user is prompted to create the outputs profiles for the programmable Intelligent Objects program. The output profiles provides all program data output fields and their properties that result either from reading data fields or results of mathematical arithmetic, algebraic or calculus operations. The user is prompted to create all the search profiles for the programmable Intelligent Objects program. The search profiles provide all program search criteria and tags associated with data input and outputs of the programmable Intelligent Object program. The user is prompted to create all the program calculations performed on any of the data inputs or outputs fields, elements and/or combinations thereof. The user is prompted to create all program logical conditions performed on any of the data inputs, outputs, elements and/or combinations thereof.

If the user was directed based on his selection where the process of generating a self-programmable Intelligent Object program begins, then the Intelligent Object New Program Generation Module displays various automated Program Models for the user to select from, i.e., analytical, suspicious, optimistic, pessimistic, shopping, friends and family, artificial intelligence, etc. These Program Models are just examples of some of the models that can be pre created for the user. There is no limit or restriction to what the Intelligent Object New Program Generation Module can process.

Basically these Program Models model various programming behaviors that can closely mimic what the user intends to get out of these different Program Models. The Program Models can be enhanced and fine tuned based on practical uses. The user selects a Program Model which will best model how the user desires the self-programmable logic to process and monitor the points and/or processes. Points are any points that the user selects to monitor using the Program Model, i.e. entry points, files, a contact or group of contacts, etc. On the other hand, a process is any process that contains certain steps or flows to be monitored by the Program Model. For example, a process can be created to monitor for quality assurance purposes all incoming calls handled by a specific customer service agent or all agents.

The Intelligent Objects New Program Generation Module displays all system points and processes and the user selects the points and/or processes to be monitored and processed by the Program Model selected by the user. The selected Program Model auto generates all input, output and search profiles, calculations and program conditions tables. The Intelligent Object New Program Generation Module generates the new programmable or self-programmable program depending on the path the user followed to generate the program. The user can save the generated program and the process is ended.

Referring to FIG. 2,

### Example 1: Unattended Services: Checkout at Brick and Mortar Store

Using a portable device [204], the consumer/user selects an Internet Object [230] as shown in FIG. 2 that will display a service link that automatically appears on the portable device [204] of the user/consumer [201] as he enters a store location, enters or scans the Unique Identifier for the store, or the user/consumer [201] can search for the store and connect over the Internet [240] to the store's Internet Objects [231] published by the store. Service provider will display via the store's published Internet Objects or dynamic dashboards [231] all the services available at the store location such as a shopping cart and a checkout options. After scanning all the purchases using his portable device [204], the user/consumer [201] selects a checkout service Internet Object [231] and the store Internet Object [231] service will display the final bill through bills Internet Object [231] and the user/consumer [201] pays the bill through the bill pay Internet Object service. Once payment is received a barcode is generated for the transaction. As the user/consumer [201] exits the store he will show the checkout barcode to the store attendant who scans the barcode and a list of the purchases appears on the attendant's display. The attendant will then physically verify the purchases against the displayed list on his terminal as the user/consumer [201] exits the store.

### Example 2: Unattended Services: ATM Cash Withdrawal Service

Using a portable device [204], and in the same manner as described in example 1 above, the portable device [204] of the consumer/user's [201] automatically displays Internet Objects or dynamic dashboards showing the nearest ATM to the current user location and/or the consumer/user [201] can manually enter his Unique Identifier which is in this case his portable device [204] number in the mobile withdrawal ATM screen option. The user [201] will receive a One Time Password on his portable device [204] that he will enter when prompted by the ATM. The user [201] makes a cash withdrawal request and collects the cash from the ATM.

### Example 3: Unattended Services: Dispensing Fuel at Petrol Stations

Using a portable device [204], and in the same manner as described in example 1 above, the portable device [204] of the consumer/user [201] automatically displays Internet Objects or dynamic dashboards showing the nearest petrol station to current user location. Once at the petrol station, the services provided by the petrol station at that particular location gets automatically displayed on the portable device [204] of the consumer/user [201] through Internet service Objects [231], or the user can enter or search manually for the petrol station location and clicks on the Internet Object [231] displayed by the petrol station for that particular location. In this case the user/consumer [201] will choose dispensing fuel and he will be optionally be queued using the petrol station location queuing system. Once a free pump becomes available, the user/consumer [201] will be notified through his portable device [204] and directed to the assigned pump. Alternatively, the user/consumer [201] will look for a free pump and goes to the pump. At the pump the user/consumer [201] clicks on the pump's icon on his portable device [204] and scan the pump's Unique Identifier to connect to the petrol pump servicing the user/consumer [201]. The petrol station system authenticates the user/consumer [201] and after the authentication process, the user/consumer [201] can start the fueling operation. When the fueling process is completed the user/consumer [201] will be billed, the user/consumer [201] select pay Internet Object [231], pays the bill received on his portable device [204] and an electronic receipt is sent to his portable device [204].

### Example 4: Attended Services

Using a portable device [204], the consumer/user [201] selects an Internet Object [230] as shown in FIG. 2 that will display a service link that automatically appears on the portable device [204] of the consumer/user [201] as he enters a service location (i.e. a bank, utilities and corporate offices, government and immigration service points, airplanes, ships, trains, etc.), enters or scans the Unique Identifier for the service location or the consumer/user [201] can search for the service location and connects to the location's Internet Objects published by the service provider. The service provider will display via the service location published internet objects or dynamic dashboards [231] all the services available at that particular service location such as queuing, a shopping cart and a checkout options, etc. Here the service location can offer a multitude of different services that can include direct communication with a service attendant, scanning the purchased items using portable device [204] of the consumer/user [201] and any other services provided by a particular service location.

A specific example of an attended service is in the case of user/consumer [201] withdrawing cash through a bank human teller. As earlier stated in the above examples, the bank location Internet Objects services or dynamic dashboards [231] are displayed to the user/consumer [201] as he enters the bank's location, the user/consumer [201] enters the bank physical location or can scan or search for the Unique Identifier for that bank location. In this case, the user/consumer [201] will choose the bank teller service and he will be queued using the bank location queuing system. Once his turn comes up, the user/consumer [201] will be notified through his portable device [204] and directed to the assigned teller. All instructions to the bank teller are given through the portable device [204] of the consumer/user [201].

The user/consumer [201] will send a request though his portable device [204] to the human teller to dispense a specific cash amount. The teller in turn will receive the authenticated instruction and hands over the cash to the user/consumer [201]. The process can apply to signing electronic forms for a loan application and any other bank services that banks want to make available to consumers through this Internet Objects [231] services.

### Example 5: Personal Services

Using a portable device [204], the consumer/user [201] selects Objects [210] or Internet Objects [231] as shown in FIG. 2 that will display Internet Objects services links or Internet or dynamic dashboards that automatically appears on the portable device [204] of the consumer/user [201] or as he clicks, enters, scans, or retrieve his personal service location using a hot spot (i.e. at home, car, office, bedroom, friends home, etc.), or enters, search scans, or retrieve the Unique Identifier for his personal service. The Objects [210] or Internet Objects [231] published by the individual consumer/user [201] for a particular service location or hot spot will display all the Objects services or dynamic dashboards available at that particular personal service location such as a garage door, a car, devices, lights etc. To get serviced the user clicks on the desired icon or link representing the service.

### Example 6: Intelligent Objects

All the above mentioned examples 1-5 use Objects that lack the capability to be programmed and thus act as merely virtual container containing things, i.e., files, links, etc. On the other hand, Intelligent Objects are Objects [210] that can be programmed or are self-programmable with data import and export capabilities to other Objects or applications. The contents of the Objects [210] or Internet Objects [230, 231] (hereinafter referred to as Intelligent Objects) can now be manipulated by the programs installed for the Intelligent Objects giving these objects additional capabilities to make decisions and take actions based on what is stored or to be stored in the Intelligent Objects. The main difference between the programmable and self-programmable Intelligent Objects is that the programmable Intelligent Objects act and behave based on the conditions and assumptions built in the program installed in a specific Intelligent Object and cannot deal with situations that have not been coded by the program developers. However, the self-programmable can be designed using advanced Artificial Intelligence programming techniques and skills that gives it human like or humanoid capabilities to deal with situations that go beyond traditional programming architectures and coding.

### Example 7: Unattended Services: Checkout at Brick and Mortar Store Using Intelligent Objects

Using a portable device [204], the consumer/user [201] selects an Internet Object [231] as shown in FIG. 2 that will display an Internet Object service link or dynamic dashboard that automatically appears on the portable device [204] of the consumer/user [201] as he enters a store location, the Internet shopping object [231] remembers the Unique Identifier for the store from previous visits if the location does not automatically brings up the store Internet Object [231]; otherwise the Intelligent Object [210] automatically searches for the stores location and brings up the store's Internet Objects [231] published by the store. The service provider will display via the store's published internet objects or dynamic dashboards [231] all the services available at the store location such as a shopping cart and a checkout options.

Now as the consumer/user [201] scans an item, an Intelligent Object program that is installed in the Intelligent Object [210] can monitor each item scanned and tells the consumer/user [201] how many of this scanned item is in his stock at home or if it is out of stock and the last price the user paid and at what store. The Intelligent Object [210] can also be programmed to give more information about a scanned item like health and additional nutritional information that is not normally provided on the items labels displayed at the store or online. After scanning all the purchases using his device, the consumer/user [201] selects a checkout service and the store Internet Object service will display the final bill through the bills Internet Object [231] and the user pays the bill through the bill pay Internet Object service [231].

As the consumer/user [201] checkouts using the Internet Object [231], the Intelligent Object [210] can automatically select which card or bank account to use depending on the amount, the location or other parameters that can be configured by the consumer/user [201] into the Intelligent Objects [210]. Once payment is received a barcode is generated for the transaction. The intelligent Objects [210] can be used to update the stocks at home of all the purchased items and can be used to send messages to family and friends if desired by the consumer/user [201] for the items bought at the store. All this can be done automatically and without any intervention by the consumer/user [201].

As the consumer/user [201] exits the store he will show the checkout barcode to the store attendant who scans the barcode and a list of the purchases appears on the attendant display. The attendant will then physically verify the purchases against the displayed list on his terminal as the consumer/user [201] exits the store. Alternatively, the consumer/user [201] can use an unattended exit lane where the consumer/user [201] needs to scan each purchased item after which the scanned items are moved through a conveyor and the consumer/user [201] goes through a gate which will unlock allowing the consumer/user [201] to exist after store's system verifies that the consumer/user [201] has scanned all the items he purchased. Unattended exit lanes are monitored and equipped with surveillance cameras.

The Intelligent Objects [210] can be used by consumer/user [201] as well as the service providers to enhance the shopping experience and the services provided to their consumer/user [201]. Also the Intelligent Objects [210] can provide vital analytics both to the service provider and consumers by capturing data about consumers shopping behaviors that are not captured by today's systems. For example, the analytics generated from the Intelligent Objects [210] can give pre-sales data that are not available except through expensive, limited and sampled market research. The Intelligent Objects [210] can capture data about what items consumers, for example, looked at or picked before choosing a specific item or not choosing an item at all. This type of research helps in introducing changes to the product offerings to maximize sales for certain products or ranges of products.

The analytics can also help advertisers move in at the right moment and offer similar or competitive items before the consumer/user [201] takes an item into his physical or virtual shopping cart. The consumer/user [201] can obtain data from his Intelligent Objects [210] analytics to give him an advantage of making purchase decisions based on unbiased data from his Intelligent Objects [210] sources and resources which could also include nested or networks of Objects [220] and Intelligent Objects [210] and information obtained through family and friends Intelligent Objects data and analytics.

The embodiments of the present invention which have been disclosed in this specification are purely for illustrative purposes and the present invention can be embodied in many other forms or carried out in other ways, without departing from the spirit or essential characteristics thereof. It is understood that the invention is not limited thereto, but is susceptible of numerous changes and modifications as known to those skilled in the art, and all such variations or modifications lies within the scope of the present invention.

We claim:

1. A system [202] for management of objects of things comprising of:
one or more objects or intelligent objects [210];
one or more nested objects or nested intelligent objects [220];
one or more internet objects or intelligent internet objects [231];
one or more nested internet objects or nested intelligent internet objects [230];
entities system [250];
server; and
one or more portable devices [204],
wherein the user [201] connects to his objects [210] or issuer of the objects through the nested object on his portable device [204] via wired or wireless communication networks, and
wherein each object can be configured by the user to define how the object is accessed and shared and type of contents it can store.

2. The system [202] according to claim 1, wherein each object [210] and its contents has a unique identifier.

3. The system [202] according to claim 1, wherein the objects [210] are linked to dynamic dash boards via one or more portable devices [203].

4. The system [202] according to claim 1, wherein the user can select the objects [210] and publish the selected objects over an internet or via one or more private networks [240] and display the objects in dynamic dash board.

5. The system [202]] according to claim 1, wherein the user can select an item or items within an object and post the selected items directly to another Object or Objects over the internet or via one or more private networks and update the status of the affected Objects on the linked dynamic dashboards.

6. The system [202] according to claim 1, wherein once published, the selected objects [210] will become internet objects [231] and are searchable and accessible over the internet or via private networks [240].

7. The system [202] according to claim 1, wherein the entities system [250] communicates and provides services directly to their users [201] through the internet objects [231] via internet or via one or more private networks [240].

8. The system [202] according to claim 1, wherein the user [201] accesses their system for management of objects of things both from their local devices and over the internet using dynamic dashboards or via private networks [240] using the portable device [204].

9. The system [202] according to claim 1, wherein the system for management of objects of things displays the internet objects [231] that are linked to the user [201] or devices based on the locations, and timings, or the like, which are conditionally displayed on the dynamic dashboards.

10. The system [202] according to claim 1, wherein the system for management of objects of things provides the user access to the local objects stored on the portable devices [204] as well as all linked objects residing on the local devices or other devices and/or clouds.

11. The system [202] according to claim 1, wherein the portable device [204] includes but not limited to mobile device or a tablet, or an iPad, or desktop devices, or wearables or other similar devices or a computer terminal or any other computer devices and/or the like.

12. The system [202] according to claim 1, wherein the system provides simple and direct media channels that are user centric and preserve direct relationships between the users [201] and service providers.

13. The system [202] according to claim 1, wherein the direct media channels between the users [201] created through the internet objects [231] can provide different types of services or links to services.

14. The system [202] according to claim 1, wherein the internet objects [231] eliminate the need to use the physical card to gain access to doors, cars, ATM(s) and other financial and non-financial services thereby reducing the security risks associated with the use of physical cards.

15. The system [202] according to claim 1, wherein the objects can be displayed to the users [201] based on certain conditions stipulated by the objects creators and providers and link to dynamic dashboards.

16. The system [202] according to claim 1, wherein the system provides object trajectories to display the paths, the objects follow to retrieve or deliver data, user interfaces and/or programs sequences or states.

17. A method for managing objects of things using a system, which can be customized by a user [201] or an organization according to their needs using portable devices [204] comprising steps of:
registering and logging of user into the system for management of objects of things through a registered portable device [204];
checking if any condition has been programmed for internet objects [210, 220, 230, 231] by creators of the object;
displaying the condition based internet objects [210, 220, 230, 231], if any of the programmed conditions are met; and
selecting the objects and publishing the selected objects in the dashboard over an internet or via one or more private networks [240].
selecting items and posting the selected items directly to objects over an internet or via one or more private networks.
communicating and sharing objects with other users registered with the objects of things management system or through other social media and communication services.

18. The method according to claim 16, wherein if the user [201] did not select the system settings then the system will open the object selected by the user [201] which will allow him to access specific objects of things.

19. The method according to claim 16, wherein when the selected object is opened, the system will display options that include but not limited to search or manage new, object settings, or the like, allowing the user to search within a specific object, objects and/or the objects of things system.

20. The method according to claim 17, wherein a user [201] is able to perform unattended services and Checkout at Brick and Mortar Store.

21. The method according to claim 17, wherein a user [201] is able to perform unattended services include but not limited to cash withdrawal at ATMs or fuel dispensing at petrol stations or the like.

22. The method according to claim 17, wherein a user [201] is able to perform attended services at service locations such as bank locations, utilities, corporate offices, government and immigration service points, airplanes, ships, trains, or the like.

23. The method according to claim 17, wherein a user [201] is able to attend to personal services at personal service locations such as a home and accesses a garage door, a car, devices, lights or the like.
